(19) United States
(12) Patent Application Publication
(10) Pub. No.: US 2019/0184306 A1
(43) Pub. Date: Jun. 20, 2019

(54) METHOD FOR RECOVERING TITANIUM (HALO) ALKOXIDE FROM A WASTE LIQUID

(71) Applicant: Clariant International Ltd, Muttenz 1 (CH)

(72) Inventors: Jing SU, Nankai, District Tianjin (CN); Chung Ping CHENG, Mountain House, CA (US); Werner Karl SCHUMANN, Efringen-Kirchen (DE)

(21) Appl. No.: 16/322,142

(22) PCT Filed: Aug. 3, 2016
(86) PCT No.: PCT/CN2016/093061

§ 371 Date: Jan. 31, 2019

(51) Int. Cl. B01D 9/00; B01D 3/10; C07F 7/28; C01G 23/02

(52) U.S. Cl. CPC B01D 9/0013; B01D 9/0059; C07B 2200/13; C07F 7/28; C01G 23/024; B01D 3/10

(57) ABSTRACT

A method for separating one or more titanium (halo) alkoxides from a liquid mixture comprising titanium tetrachloride TiCl₄ and at least one titanium (halo) alkoxide, said method comprising: agitating and cooling the liquid mixture until crystallization of at least one titanium (halo) alkoxide occurs in the liquid mixture; separating the crystallized titanium (halo) alkoxide from the mixture; and optionally, washing the separated, crystallized titanium (halo) alkoxide with a solvent.

### BACKGROUND OF THE INVENTION

### Field of the Invention

The present invention pertains to a method of recovering titanium (halo) alkoxide from a liquid mixture containing titanium tetrachloride (TiCl₄) and at least one titanium (halo) alkoxide. Particularly, said liquid mixture may be generated from the manufacture of titanium-based catalysts for olefin polymerization. More particularly, said waste liquid may comprise further components such as conventional electron donors, a hydrocarbon solvent, and additional chemical complexes formed from the titanium-based catalyst manufacture process.

### Description of Related Art

In the modern polyolefin production processes and especially for polypropylene production, a titanium-based Ziegler-Natta catalyst is often used. Processes for making such Ziegler-Natta catalyst have been long known in the art and described in many patents, such as U.S. Pat. Nos. 3,759,884, 3,993,588, and 4,728,705. Typically, these processes generate a large waste stream containing, inter alia, unreacted TiCl₄, one or more hydrocarbon solvents, one or more titanium (halo) alkoxides, and other reaction by-products such as aromatic and/or aliphatic (di)esters and (di)ethers coming from conventional electron donors.

Conventionally, the waste stream is further treated by atmospheric distillation, to recover both TiCl₄ and the used hydrocarbon solvents. The temperature of the distillation column is selected such that TiCl₄ is collected from the top of the column, and the titanium (halo) alkoxides remain dissolved in the bottom along with other by-products, which are eventually disposed in a liquid form. However, a simple distillation treatment can only achieve a partial recovery of the TiCl₄ component. This is because, while higher bottom temperature in the distillation unit is theoretically preferred to increase TiCl₄ recovery, in practice it often induces decomposition and cracking of some by-products in the treated stream, which eventually lead to fouling and blockage problem of the distillation unit.

Thus, there has been a continuous effort in the art to provide an effective process for treating said waste stream to reach a good TiCl₄ recovery while preventing solid formation from other un-recycled components. For instance, U.S. Pat. No. 5,242,549 disclosed a process which adds to the treated stream a separation solvent with a boiling point between TiCl₄ and the titanium (halo) alkoxides present, and then passes the resulting mixture to a first and second distillation zone, where TiCl₄ and the separation solvent are obtained from the upper portion respectively. Later published U.S. Pat. No. 5,866,750 disclosed an improved process using the same separation solvent and 2-step distillation approach as U.S. Pat. No. 5,242,549, only adding an aqueous base solution hydrolysis treatment to the alkoxides/separation solvent mixture, to precipitate the titanium compounds therein before the second distillation treatment. Similarly, U.S. Pat. No. 4,683,215 discloses a separation process which employs an organic acid halide to react with titanium halo alkoxides, in order to remove said titanium halo alkoxides from the waste stream before further treatment.

However, while the addition of further chemicals or solvents in the waste stream as taught in the above references may assist in an effective separation of one or more components in the stream, such addition will inevitably increase the separation cost and add environmental burden for final waste disposal. Thus, aiming to obviate the needs of adding chemicals to the waste stream for a high TiCl₄ recovery, U.S. Pat. No. 7,045,480 disclosed a process characterized by a thermal treatment step (e.g., at atmospheric pressure and a temperature of at least 160° C.), of which the conditions are chosen such that the residue of the waste stream from the thermal treatment step is a final waste product in the form of particulate matter at a temperature of 20° C. U.S. Pat. No. 7,976,818 discloses another method for recovering TiCl₄ from the waste stream using thermal treatment, the method comprising subjecting a flowing waste liquid film to an evaporation step comprising a residence time of less than 15 minutes at a temperature from 90° C. to 150° C., without cracking and decomposition of the by-products.

Nevertheless, the separation methods which rely on thermal treatments also have their inherent drawbacks from the viewpoints of energy saving and high equipment requirements. Moreover, in all the aforementioned separation methods, only TiCl₄ component is effectively separated in a substantively pure form for re-use, and other titanium containing components were simply disposed as waste.

Thus, there is need of finding a new separation process which could recover more than one titanium component, to minimize the amounts of final waste from the production of Ziegler-Natta catalyst and other titanium-based olefin polymerization catalyst.

### SUMMARY OF THE INVENTION

The present invention provides a method for separating one or more titanium (halo) alkoxides from a liquid mixture comprising titanium tetrachloride TiCl₄ and at least one titanium (halo) alkoxide, said method comprising: cooling the liquid mixture until crystallization of at least one titanium (halo) alkoxide occurs in the liquid mixture; separating the crystallized titanium (halo) alkoxide from its mother liquor; and optionally, distilling said mother liquor to separate titanium tetrachloride therefrom.

### BRIEF DESCRIPTION OF THE DRAWING

FIG. 1 is a diagrammatic representation of one embodiment of the present invention. As shown in FIG. 1, a liquid mixture 1 containing TiCl₄ and titanium (halo) alkoxide is firstly fed into a cooling crystallization unit (A), in which agitation of said liquid mixture is preferably maintained, to form a slurry 2 containing crystal of titanium (halo) alkoxide 3. Said slurry 2 is then fed to a solid-liquid separation unit (B), to separate the crystalline titanium (halo) alkoxide solid 3 from its mother liquor 4. Subsequently, the mother liquor 4 is subjected to a vacuum distillation in a distillation column (C), to obtain TiCl₄ 5 from the top of the distillation column and a liquid residue 6 from the column bottom as the final waste.

FIG. 2 is a diagrammatic representation of another embodiment of the present invention. The set-up of FIG. 2 is identical to FIG. 1, except that the liquid residue 6 from the distillation column (C) is returned to the cooling crystallization unit (A), to recover more crystallized titanium (halo) alkoxide from the original liquid mixture 1.

### DETAILED DESCRIPTION OF THE INVENTION

The method of the invention facilitates the separation and recovery of titanium (halo) alkoxide from a liquid mixture comprising titanium tetrachloride TiCl₄, at least one titanium (halo) alkoxide, and optionally other chemical compounds such as aromatic esters and the like, wherein the titanium (halo) alkoxide is of the formula TiXₓ(OR)_{y} where X is halogen, R is alkyl and mostly C1-C10 lower alkyl, x=0-3, y=1-4 and x+y=4. Although the invented method is broadly applicable to separation of such a liquid mixture regardless of its origin, it is found particularly suitable for the separation and recovery of titanium (halo) alkoxide from a waste liquid resulting from production of a titanium-based olefin polymerization catalyst, e.g., by contacting a magnesium alkoxide or a magnesium chloride-alcohol adduct with titanium tetrachloride in the presence of a hydrocarbon reaction diluent. More particularly, said waste liquid is usually a complex mixture of titanium tetrachloride, titanium (halo) alkoxides, aromatic esters and a hydrocarbon reaction diluent, as well as various complexes of titanium (halo) alkoxide compounds with other titanium (halo) alkoxide compounds or with the aromatic esters. Said hydrocarbon reaction diluent can be selected from aliphatic solvents (e.g., heptane or decane) and aromatic solvents (e.g., chlorobenzene, dichlorobenzene, and chlorotoluene). Said aromatic esters are preferably alkyl benzoates such as ethyl benzoate and ethyl p-ethyl benzoate, or alkylphthalates such as diethyl phthalate or diisobutyl phthalate.

The present invention provides a convenient method for recovering titanium (halo) alkoxide from a liquid mixture as aforementioned, and particularly a waste liquid comprising titanium tetrachloride, at least one titanium (halo) alkoxide and other by-products from production of a titanium-based olefin polymerization catalyst, said method comprising: cooling the liquid mixture until crystallization of at least one titanium (halo) alkoxide occurs in the liquid mixture; separating the crystallized titanium (halo) alkoxide from its mother liquor; and optionally, distilling said mother liquor to separate titanium tetrachloride therefrom. As used herein, the titanium (halo) alkoxide is of the formula TiXₓ(OR)_{y} where X is halogen, R is alkyl and mostly C1-C10 lower alkyl, x=0-3, y=1-4 and x+y=4. Preferably, R is selected from the group consisting of ethyl, n-propyl, isopropyl, n-butyl, sec-butyl, isobutyl, tert-butyl, n-amyl, isoamyl, tert-amyl, and sec-isoamyl. More preferably, R is a primary alkyl. Preferably, X is chlorine, bromine, or fluorine, chlorine being most preferred. In one preferred embodiment, the titanium (halo) alkoxide recovered by the inventive process is ethoxytitanium trichloride (TiCl₃OC₂H₅).

Compared to prior art processes to recycle a typical waste liquid mixture coming from titanation of solid catalyst components, the method of the present invention advantageously achieves a higher total recovery rate of titanium-based components of value, and ultimately reduces the burden of waste management in production of a titanium-based olefin polymerization catalyst such as Ziegler-Natta catalyst.

According to the present invention, any conventional cooling crystallization equipment can be used to perform the cooling crystallization of titanium (halo) alkoxide from the liquid mixture. Usually, such conventional cooling crystallization equipment is made of an internal cooling batch system in which a coolant is introduced into a horizontal jacket or an agitating part or ribbon mixer thereof, or a continuous system which is a mere combination of a number of the above batch systems. Suitable cooling crystallization equipment for the present invention includes a conventional stirred reactor equipped with an outer cooling jacket, and a combination of multiple such stirred reactors to facilitate a continuous operation.

In specific embodiments of the present invention, a liquid mixture comprising TiCl₄ and at least one titanium (halo) alkoxide is introduced into a cooling crystallization equipment, where the liquid mixture is usually cooled to a temperature between −20° C. and 25° C., and preferably between −10° C. and 10° C. The residence time of the liquid mixture in the cooling crystallization equipment is usually between 30 minutes to 15 hours, and preferably between 1 hour to 5 hours, during which time said liquid mixture is preferably stirred or otherwise kept in motion to facilitate the cooling crystallization process and to ensure an efficient heat transfer. Preferably, the liquid mixture is continuously or intermittently agitated in the cooling crystallization equipment, the agitation being sufficient to maintain the mixture homogenous. In particular, it is found that a continuous agitation of the liquid mixture could advantageously promote crystallization formation for titanium (halo) alkoxide.

To obtain well-formed crystals of titanium (halo) alkoxide, it is often advantageous to allow the crystal mash to remain for a long period (e.g. 1 to 5 hours) without stirring, at a temperature between 0° C. and 25° C., either in the cooling crystallization equipment or in a separate container.

According to the invention, separating the crystallized titanium (halo) alkoxide from its mother liquor may be carried out by any conventional separation equipment, and preferably those in which it is possible to wash the separated product. Examples of such separation equipment include decanter, filter presses, vacuum filters, pressure filters and centrifuges, among which centrifuges are preferred. A particularly preferred type of centrifuge is a decanter centrifuge. Advantageously, centrifugation separation could largely increase the separation efficiency while maintaining a good crystalline morphology, compared to the traditional filtration separation approach. Using otherwise identical conditions in the inventive process, centrifuge separates out substantially dry titanium (halo) alkoxide crystalline in fine powder form, while a Funda filter could only separate out crystallized titanium (halo) alkoxide in paste form with much larger moisture.

Optionally, the separated titanium (halo) alkoxide crystals are washed with an inert solvent, which may be miscible or immiscible with titanium (halo) alkoxides but should not react therewith. Suitable examples of said inert solvents include alkanes or alkane mixtures, especially those having 4 to 10 carbon atoms, e.g. octane, butane, pentane or hexane, cycloalkanes having 5 to 10 carbon atoms, e.g. cyclohexane or cyclooctane, aromatic or arylaliphatic hydrocarbons having 6 to 10 carbon atoms, e.g. benzene, toluene, xylene, or low-boiling alkanols, especially those having 1 to 8 carbon atoms, e.g. methanol, ethanol, propanols, butanols, hexanols or octanols, dialkylketones, especially those having 3 to 9 carbon atoms, e.g. acetone, methyl ethyl ketone, diethyl ketone, diisopropyl ketone or dibutyl ketone, or open or cyclic ethers, especially those with 2 to 4 carbon atoms, e.g. diethyl ether, tetrahydrofuran or dioxane. Halogenated hydrocarbons, e.g. methyl chloride, methylene chloride, chloroform, carbon tetrachloride, trichloroethylene, chlorobenzene, bromobenzene or dichlorobenzenes, or esters, especially of lower fatty acids with lower alcohols, e.g. methyl acetate, ethyl acetate, butyl acetate, ethyl propionate, butyl propionate, methyl butyrate or ethyl butyrate and even water may also be used for washing the separated titanium (halo) alkoxide crystals. One preferred example of said inert solvent is hexane.

Washing of the crystals may be carried out in a separate washing container; or more advantageously on the separation apparatus itself, for example on a pressure or vacuum filter or a pusher centrifuge. The washing liquid obtained by washing the crystals should be collected separately for proper recycling. Optionally, the washed crystals are further dried by an inert gas such as gaseous nitrogen.

Advantageously, by treating a typical waste liquid coming from production of a titanium-based Ziegler-Natta catalyst using cooling crystallization as in the present invention, high-purity titanium (halo) alkoxide crystalline solid can be separated from the liquid phase, which contains over 90 wt % of titanium (halo) alkoxide as measured by gas chromatography after drying.

Preferably, after separating the crystallized titanium (halo) alkoxide from its mother liquor, the method of the present invention also comprises a step of distilling said mother liquor to separate titanium tetrachloride therefrom. In specific, said step can be fulfilled by subjecting said mother liquor to vacuum distillation to separate titanium tetrachloride as a distillate.

According to an exemplary embodiment, the TiCl₄-comprising mother liquor is subjected to a distillation step operated under vacuum. Preferably the distillation is operated at a pressure ranging from 2 kPa to 30 kPa, taking into account that, as known to one skilled in the art, the values of pressure in a distillation column differ along its height and increase from the top to the bottom of the column. Generally, the bottom temperature of such distillation operation is controlled to be lower than 100° C. In practice, a vacuum distillation treatment to said TiCl₄-comprising mother liquor could achieve a good recovery of TiCl₄, normally at least 85% by weight of a substantially pure TiCl₄ from the top of the distillation column. This recovered TiCl₄ can be stored for the successive use or directly recycled to the reactor for the titanation of solid catalytic components, e.g. the manufacture of titanium-based olefin-polymerization catalysts.

The resulting distillation residue can be further treated depending on the specific recycle specifications and local waste regulations, or alternatively recycled to one cooling crystallization equipment as aforementioned to separate more crystallized titanium (halo) alkoxide therefrom. Accordingly, the method of the present invention results in a final waste material less hazardous than the conventional waste material, which emits less HCl vapor when exposed to moist air at room temperature.

The invention is further illustrated by the following examples.

### Example 1

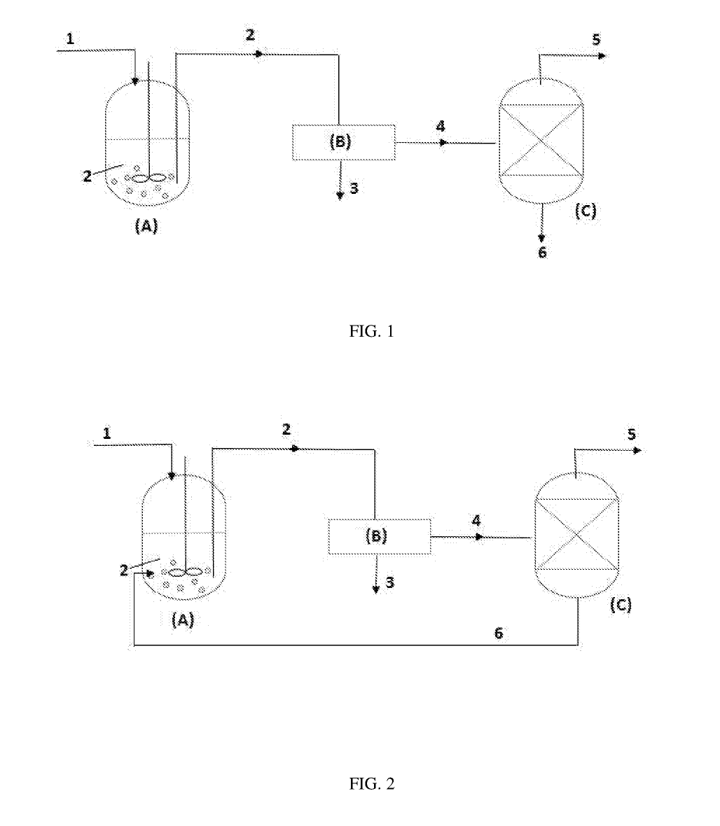

900 grams of a waste liquid 1 generated from a process to make a Ziegler-Natta catalyst for the polypropylene production was subjected to the method of the present invention, carried out by means of the process set-up illustrated in FIG. 1. Said waste liquid 1 comprised approximately 89 wt % of TiCl₄, 10 wt % of Ti-chloroalkoxide compounds and 0.5-1 wt % di-isobutyl-phthalate (DiBP) as major components.

Firstly, the hot waste liquid 1 exiting the reaction vessel was cooled with a coolant in an outer cooling jacket of a longitudinally extending crystallizer (A). The temperature inside the crystallizer was maintained at approximately 10° C., and the waste liquid was continuously agitated by a rotor revolving within the cooling crystallizer, at a rate of 400 rpm for 3 hours. The resulting slurry 2 was then filtered by a filter (B), and the separated crystalline solid 3 was further washed by hexane and dried by gaseous nitrogen, to obtain 62 gram of white to pale yellow crystals which contain roughly 90 wt % of ethoxytitanium trichloride (TiCl₃OC₂H₅), and less than 1 wt % of DiBP-TiCl₄ as measured by gas chromatography.

The collected filtrate 4 was then fed to a distillation column (C) operating at vacuum condition: 2 kPa at the top and 30 kPa at the bottom of the column. The bottom and top temperatures of the distillation column were maintained at about 98° C. and 90° C., respectively. The residence time of the liquid filtrate 4 inside the distillation column was about 120 minutes. 693 g of a substantially pure TiCl₄ 5 were obtained from the top of the distillation column, and 29.9 g of a liquid residue 6 were withdrawn from the bottom of the distillation column.

### Example 2

Example 1 was essentially repeated for another 900 grams of a waste liquid from the same Ziegler-Natta catalyst production process, except that the liquid residue (a total of about 30 gram) withdrawn from the bottom of the distillation column (C) was delivered back to crystallizer (A) as in FIG. 2, for a repeated cooling crystallization treatment at the same operative conditions: an internal temperature maintained at 10° C. with a continuous agitation at a constant rate of 400 rpm for 3 hours. After filtration through the filter (B), hexane washing and subsequent nitrogen drying, 8.2 gram of a white to pale yellow crystalline solid was obtained, which consists of >90 wt % of ethoxytitanium trichloride (TiCl₃OC₂H₅) and <1 wt % of DiBP-TiCl₄ as measured by gas chromatography.

### Example 3

140 kg of a waste liquid 1 generated from a process to make a Ziegler-Natta catalyst for the polypropylene production was subjected to the method of the present invention, carried out by means of the process set-up illustrated in FIG. 1. Said waste liquid 1 comprised approximately 89 wt % of TiCl₄, 10 wt % of Ti-chloroalkoxide compounds and 0.5-1 wt % di-isobutyl-phthalate (DiBP) as major components.

Firstly, the hot waste liquid 1 exiting the reaction vessel was cooled with a coolant in an outer cooling jacket of a longitudinally extending crystallizer (A). The temperature inside the crystallizer was maintained at approximately −5° C., and the waste liquid was continuously agitated by a rotor revolving within the cooling crystallizer, at a rate of 100 rpm for 3 hours. The resulting slurry 2 was then filtered by a filter (B), and the separated crystalline solid 3 was further washed by hexane and dried by gaseous nitrogen, to obtain 4.5 kg of white to pale yellow crystals which contain roughly 90 wt % of ethoxytitanium trichloride (TiCl₃OC₂H₅), and less than 1 wt % of DiBP-TiCl₄ as measured by gas chromatography.

Finally, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A method for separating titanium (halo) alkoxide from a liquid mixture comprising titanium tetrachloride TiCl4 and at least one titanium (halo) alkoxide, said method comprising: cooling the liquid mixture until crystallization of at least one titanium (halo) alkoxide occurs in the liquid mixture; separating the crystallized titanium (halo) alkoxide from its mother liquor by a separation equipment selected from the group of decanter, filter presses, vacuum filters, pressure filters and centrifuges; and optionally, distilling said mother liquor to separate titanium tetrachloride therefrom, wherein the titanium (halo) alkoxide is of the formula TiXx(OR)y where X is halogen, R is alkyl, x=0-3, y=1-4 and x+y=4.

2. The method according to claim 1, wherein the crystallized titanium (halo) alkoxide is separated from its mother liquor by centrifugation.

3. The method according to claim 2, wherein a decanter centrifuge is used for separating the crystallized titanium (halo) alkoxide from its mother liquor.

4. The method according to claim 1, wherein the liquid mixture is a waste liquid resulting from production of a titanium-based olefin polymerization catalyst.

5. The method according to claim 1, wherein the liquid mixture is a waste liquid resulting from production of a titanium-based olefin polymerization catalyst, by contacting a magnesium alkoxide or a magnesium chloride-alcohol adduct with titanium tetrachloride in the presence of a hydrocarbon reaction diluent.

6. The method according to claim 1, wherein the liquid mixture comprises titanium tetrachloride, titanium (halo) alkoxides, aromatic esters, a hydrocarbon reaction diluent, and complexes of titanium (halo) alkoxide compounds with other titanium (halo) alkoxide compounds or with the aromatic esters.

7. The method according to claim 1, wherein the liquid mixture is cooled to a temperature between −20° C. and 25° C. and preferably between −10° C. and 10° C.

8. The method according to claim 7, wherein the liquid mixture is continuously or intermittently agitated in the cooling crystallization equipment.

9. The method according to claim 8, wherein the liquid mixture is continuously agitated in the cooling crystallization equipment.

10. The method according to claim 7, wherein the residence time of the liquid mixture in the cooling crystallization equipment is between 30 minutes to 15 hours, preferably between 1 hour to 5 hours.

11. The method according to claim 8, wherein the cooling crystallization equipment is a stirred reactor equipped with an outer cooling jacket for batch operation, or a combination of multiple said stirred reactors for continuous operation.

12. The method according to claim 1, wherein the method further comprises washing the separated titanium (halo) alkoxide crystals with an inert solvent.

13. The method according to claim 1, which comprises subjecting said mother liquor to vacuum distillation to separate titanium tetrachloride as a distillate.

14. The method according to claim 13, which comprises recycling the distillation residue resulted from the vacuum distillation to a cooling crystallization equipment, and separating crystallized titanium (halo) alkoxide from said distillation residue.

15. The method according to claim 13, wherein the distillation is operated at a pressure ranging from 2 kPa to 30 kPa.
